(19) United States
(12) Patent Application Publication
(10) Pub. No.: US 2003/0191265 A1
(43) Pub. Date: Oct. 9, 2003

(54) Preparation of allylic copolymers of broad molecular weight distributions

(76) Inventor: Wei Wang, Boothwyn, PA (US)

Correspondence Address: LYONDELL CHEMICAL COMPANY, 3801 WEST CHESTER PIKE, NEWTOWN SQUARE, PA, 19073, US

(21) Appl. No.: 10/115,683

(22) Filed: Apr. 4, 2002

(51) Int. Cl. C08F 118/02

(52) U.S. Cl. 526/319; 526/336; 526/346; 526/335

(57) ABSTRACT

A process for making an allylic copolymer is disclosed. The process is a free radical copolymerization of an aqueous dispersing agent and a monomer mixture comprising a mono-ethylenic monomer, a multi-ethylenic monomer, and a mono-allylic monomer. The preferred aqueous dispersing agent is water. The copolymer produced has a high molecular weight and a broad molecular weight distribution, and it is particularly useful as a toner resin.

### BACKGROUND OF THE INVENTION

1. Field of the Invention

The invention relates to the preparation of allylic copolymers. More particularly, the invention relates to the preparation of allylic copolymers that have broad molecular weight distributions. The copolymers are particularly useful, for example, as toner resins.

2. Background Art

Allyl alcohol and allyl alcohol alkoxylates are useful, unique, hydroxyl functional monomers. They readily copolymerize with most commonly used monomers, e.g., vinyl aromatics, acrylates and methacrylates, vinyl ethers and esters, vinyl halides, conjugated dienes, and many others. These allylic monomers not only contribute hydroxyl functionality to the copolymers, but they also regulate the molecular weight of the copolymers and control the polymerization rate. When even a small portion of allylic monomer is used, a low molecular weight polymer is produced.

U.S. Pat. No. 5,382,642 teaches how to prepare copolymers of vinyl aromatics and allyl alcohol propoxylates. The copolymers have hydroxyl numbers of 80-260 mg KOH/g, and number average molecular weights from 500 to 3,500. They are particularly useful for polyurethane, alkyd, and melamine coatings.

U.S. Pat. No. 5,451,652 teaches how to prepare homopolymers of allyl alcohol propoxylates, and copolymers of allyl alcohol and allyl alcohol propoxylates. These polymers are highly hydroxyl-functionalized, and are particularly useful as crosslinking agents.

U.S. Pat. No. 5,475,073 teaches how to prepare hydroxyl acrylic resins by substituting allyl alcohol and allyl alcohol propoxylates for hydroxyalkyl acrylates or methacrylates. By using the allylic monomers, low molecular weight resins are advantageously produced without the need for a chain transfer agent or solvent. The resins have hydroxyl numbers from 50 to 450 mg KOH/g, and number average molecular weights from 500 to 10,000. They are particularly useful for acrylic-urethane and acrylic-melamine coatings.

U.S. Pat. No. 5,480,954 teaches how to prepare copolymers of allyl esters with allyl alcohol or allyl alcohol propoxylates. Compared with the polymers taught in U.S. Pat. No. 5,451,652, these copolymers have lower hydroxyl numbers, improved solubility in organic solvents, and better compatibility with other resins.

U.S. Pat. No. 5,646,225 teaches how to prepare water-soluble or water-dispersible resins. These resins are prepared by copolymerizing an allyl alcohol propoxylate, a vinyl aromatic monomer, and acrylic acid. They are particularly useful in water-borne coatings and inks.

The polymers disclosed in the above U.S. patents all have low molecular weights and narrow molecular weight distributions. They are highly valuable as hydroxyl functional resins in high-solids or low-VOC coatings because their low molecular weights and narrow molecular weight distributions give low solution viscosities.

Allylic copolymers having high molecular weights and broad molecular weight distributions are needed, for example, in toner resins. However, they are difficult to prepare.

Commonly used toner resins are high molecular weight copolymers of styrene and butadiene, or styrene and acrylates. Usually, they are prepared by suspension or emulsion polymerization. Toner resins usually require broad molecular weight distributions or bimodal distributions because the low molecular weight portion gives the toner low melt viscosity and good flexibility, while the high molecular weight portion improves anti-offset and anti-winding characteristics.

U.S. Pat. No. 5,219,947 teaches how to prepare a toner resin by a two-stage polymerization process. In the first stage, a low molecular weight polymer is formed in a solution polymerization. In the second stage, the low molecular weight polymer from the first stage is dissolved in a monomer, and the monomer is then polymerized by a suspension polymerization. The preparation is rather complicated not only because there are two different polymerization processes involved, but also because both the organic solvent from the first stage and water from the second stage must be removed from the product.

U.S. Pat. No. 5,986,031 teaches how to prepare high molecular weight, broad molecular weight distribution, allylic copolymers. These copolymers are particularly useful as toner resins. They are prepared by copolymerizing an ethylenic monomer, a monofunctional allyl monomer, and a multifunctional allyl monomer. No solvent is needed in the preparation. However, removing the unreacted multifunctional allyl monomer, such as diallyl phthalate, is found to be very difficult.

U.S. Patent Nos. 6,350,842 and 6,362,297 teach how to prepare high molecular weight, broad molecular weight distribution (bimodal) allylic copolymers in a one-step process. Mixing is relatively difficult in this process as a result of the high melt viscosity of the bimodal copolymer.

New methods for preparing allylic copolymers of high molecular weight and broad molecular weight distribution are needed. Ideally, the preparation does not require the use of a multifunctional allylic monomer and results in relatively low viscosity mixtures throughout the process.

### SUMMARY OF THE INVENTION

The present invention comprises a process for preparing an allylic copolymer that has a relatively broad molecular weight distribution. The process comprises free radically copolymerizing a monomer mixture comprising a mono-ethylenic monomer, a multi-ethylenic monomer, and a mono-allylic monomer, with an aqueous dispersing agent to produce an allylic copolymer that has a high molecular weight, a broad molecular weight distribution, and a low gel content.

The invention produces an allylic copolymer that comprises about 0.1% by weight to about 10% by weight of multi-ethylenic monomeric units, about 5% by weight to about 40% by weight of mono-allylic monomer units, and about 50% by weight to about 95% by weight of mono-ethylenic monomeric units, based on the total weight of the copolymer. The polymer has a weight average molecular weight greater than about 10,000, a molecular weight distribution (Mw/Mn) greater than about 5, and a gel content less than about 10% by weight. It is particularly useful as a toner resin.

### DETAILED DESCRIPTION OF THE PREFERRED EMBODIMENT

The process of the invention comprises free radically copolymerizing a monomer mixture containing a) a mono-ethylenic monomer, b) a multi-ethylenic monomer, and c) a mono-allylic monomer, with an aqueous dispersing agent.

The mono-ethylenic monomer suitable for use in the invention has one free radically polymerizable group. Preferably, the group is —CR═CH₂, wherein R is hydrogen, or C₁ to C₁₀ alkyl. Examples of suitable mono-ethylenic monomers are vinyl aromatics, vinyl halides, vinyl ethers, vinyl esters, unsaturated nitrites, acrylic and methacrylic acids and their esters, conjugated dienes, and the like, and mixtures thereof. Preferred mono-ethylenic monomers are vinyl aromatics, C₁ to C₁₀ alkyl acrylates and methacrylates, and conjugated dienes. Particularly preferred are styrene, methyl methacrylate, butyl methacrylate, butyl acrylate, isoprene, and butadiene. More preferred are mixtures of styrene with butyl acrylate, and styrene with butadiene.

Usually, the mono-ethylenic monomer is the major component of the monomer mixture. The amount used is determined by many factors, particularly the desired glass transition temperature (T_{g}) of the copolymer. For toner applications, the copolymer is required to have a T_{g} greater than about 50° C. Copolymers of the invention preferably have glass transition temperatures within the range of about 50° C. to about 85° C. A more preferred range is from about 55° C. to about 70° C. The T_{g} of the copolymer is essentially determined by the monomeric type and comonomer ratio. For example, when a low T_{g} mono-allylic monomer is used, a relatively large amount of a high T_{g} mono-ethylenic monomer is required to achieve a high T_{g} copolymer. The mono-ethylenic monomer is usually used in an amount greater than about 50% by weight of the copolymer composition.

The multi-ethylenic monomer suitable for use in the invention preferably contains more than one free radically polymerizable ethylenic group as defined above. Examples are divinyl aromatics, diacrylates, and dimethacrylates. Preferred multi-ethylenic monomers are divinyl benzene (DVB), and ethylene glycol dimethacrylate.

The amount of multi-ethylenic monomer used is important because it determines the molecular weight of the copolymer. The multi-ethylenic monomer has two or more reactive carbon-carbon double bonds that participate in the polymerization. This results in polymeric chain branching and an increase in copolymer molecular weight. Using too much multi-ethylenic monomer causes gel formation during polymerization. Gel formation is undesirable because it causes difficulty in product isolation and reactor cleaning-up. Moreover, the highly crosslinked copolymer is less desirable in toner applications.

It is essential to use the multi-ethylenic monomer in the presence of a mono-allylic monomer. Without a mono-allylic monomer, using the multi-ethylenic monomer causes gel formation.

The amount of the multi-ethylenic monomer used depends on the amount of mono-allylic monomer used. The multi-ethylenic monomer is usually used in an amount less than 15% by weight of the monomer mixture. More preferably, it is used in an amount less than 5% by weight of the monomer mixture.

Mono-allylic monomers suitable for use in the invention contain a single allylic double bond. Suitable mono-allylic monomers include allylic alcohols, alkoxylated allylic alcohols, allyl ethers, allyl esters, allyl amines, allyl carbonates, and the like, and mixtures thereof. Examples of allylic alcohols are allyl alcohol, methallyl alcohol, and 2-ethyl-2-propen-1-ol. Allyl alcohol is preferred because it is commercially available.

Alkoxylated allylic alcohols suitable for use in the invention include alkoxylation products of allyl alcohol and methallyl alcohol with ethylene oxide, propylene oxide, and the like, and mixtures thereof. Preferred alkoxylated allylic alcohols have less than 10 units of oxylalkylene. Preferred alkoxylated allylic alcohols include allyl alcohol monopropoxylate and allyl alcohol monoethoxylate because they have relatively low boiling points and easier to remove from the copolymer product after polymerization.

Preferred allyl ethers include C₁-C₁₀ alkyl and aryl allyl ethers and methallyl ethers. Examples of suitable allyl ethers are allyl methyl ether, methallyl methyl ether, allyl ethyl ether, allyl t-butyl ether, and the like, and mixtures thereof.

Preferred allyl esters include allyl esters and methallyl esters of C₁-C₁₂ aliphatic or aromatic acids. Examples of suitable allyl esters are allyl acetate, methallyl acetate, allyl butyrate, allyl formate, allyl benzoate, and the like, and mixtures thereof.

Preferred allyl amines include allyl amine, methallyl amine, C₁-C₁₂ alkyl or aryl N-substituted allyl amines or methallyl amines, and the like, and mixtures thereof. Examples of suitable allyl amines are allyl amine, methallyl amine, N-methyl allyl amine, N-butyl allyl amine, N-benzyl allyl amine, N,N-dimethyl allyl amine, N,N-dibutyl methallyl amine, and the like, and mixtures thereof.

Preferred allyl carbonates include C₁-C₁₂ alkyl and aryl allyl carbonates and methallyl carbonates. Examples of suitable allyl carbonates are methyl allyl carbonate, methyl methallyl carbonate, ethyl allyl carbonate, and the like, and mixtures thereof.

It is essential to use the mono-allylic monomer in combination with a multi-ethylenic monomer because without the multi-ethylenic monomer, the process produces only a copolymer having a low molecular weight and a narrow molecular weight distribution.

The amount of the mono-allylic monomer used depends on many factors, particularly the amount of a multi-ethylenic monomer used. The mono-allylic monomer functions as a crosslinking retardant that reduces the gel formation. Generally, when more multi-ethylenic monomer is used, more mono-allylic monomer is needed. When the multi-ethylenic monomer is used in an amount from about 0.1% to about 5% by weight, the mono-allylic monomer is preferably used in an amount from about 5% to about 25% by weight of the monomer mixture. When the multi-ethylenic monomer is used in an amount from about 5% to about 20% by weight, the mono-allylic monomer is preferably used in an amount from about 25% to about 40% by weight of the monomer mixture.

An excess of mono-allylic monomer is usually needed to incorporate a sufficient amount of it into the copolymer. The unreacted mono-allylic monomer is then removed from the copolymer after polymerization by distillation.

The aqueous dispersing agent can be any suitable agent that is capable of stabilizing the dispersion of the reaction media and the formed copolymer. Examples of suitable dispersion agents include, but are not necessarily limited to, water, and aqueous solutions of colloidal stabilizers and/or surfactants. If aqueous solutions of colloidal stabilizers and/or surfactants are employed as the dispersing agent, it is preferred that the dispersing agent contain at least about 90 weight percent water, based on the total weight of the dispersing agent, more preferably at least about 95 weight percent, and most preferably at least about 98 weight percent. Suitable examples of colloidal stabilizers include, but are not necessarily limited to, polyvinyl alcohol, soluble starch, hydroxyethyl cellulose, sodium stearate, and sodium dodecylbenzene sulfonate. Suitable examples of surfactants include, but are not necessarily limited to, anionic-, cationic- and non-ionic surfactants.

Preferably, the aqueous dispersing agent is present in an amount of about 4 to about 50 weight percent, based upon the total weight of the material charge/reaction mixture (i.e., the monomer mixture and the dispersing agent), more preferably about 7 to about 30 weight percent, and most preferably in an amount of about 10 to about 20 weight percent. The most preferred dispersing agent is water.

The process of the invention is a free-radical, polymerization. Generally, the mono-allylic monomer and the aqueous dispersing agent are added into the reactor before the polymerization starts. Usually, the mono-ethylenic and multi-ethylenic monomers are gradually fed during the polymerization. It is preferred to add at least about 50% by weight, preferably at least about 70% by weight, of the mono-ethylenic and the multi-ethylenic monomers to the reaction mixture gradually, i.e., over a time period of 4 to 8 hours. Preferably, the mono-ethylenic and the multi-ethylenic monomers are added at rates effective to maintain their steady, low concentrations in the reaction mixture. Preferably, the ratio of mono-allylic monomer to mono-ethylenic and multi-ethylenic monomers is kept essentially constant; this helps to produce a resin having a relatively uniform composition. Gradual addition of the mono-ethylenic and the multi-ethylenic monomers enables the preparation of a copolymer having a desired molecular weight and molecular weight distribution and having a minimum amount of gel formation.

Suitable free radical initiators include peroxides, hydroperoxides, axo compounds, and many others known to the polymer industry. Examples of suitable free radical initiators are hydrogen peroxide, di-t-butyl peroxide, t-butyl hydroperoxide, cumene hydroperoxide, 2,2′-azobisisobutyronitrile, and the like, and mixtures thereof. Generally, it is preferred to add the free radical initiator to the reactor gradually during the course of the polymerization; it is also desirable to match the addition rate of the free-radical initiator to the addition rates of the mono-ethylenic and the multi-ethylenic monomers.

It was surprisingly found that reacting a combination of an aqueous dispersing agent, with a monomer mixture comprising a mono-allylic monomer, a multi-ethylenic monomer, and a mono-ethylenic monomer produces an allylic copolymer having a high molecular weight and a broad molecular weight distribution without gel formation during polymerization and without creating relatively high melt viscosities. The resulting allylic copolymer comprises a mono-ethylenic monomeric unit, a multi-ethylenic monomeric unit, and a mono-allylic monomeric unit. Suitable mono-ethylenic, multi-ethylenic, and mono-allylic monomers are discussed above. Preferably, the copolymer comprises about 0.1% by weight to about 10% by weight of multi-ethylenic monomeric units, about 5% by weight to about 40% by weight of mono-allylic monomeric units, and about 50% by weight to about 95% by weight of mono-ethylenic monomeric units based on the total weight of the copolymer. The copolymer has a weight average molecular weight greater than about 10,000, a molecular weight distribution (Mw/Mn) greater than about 5, and a gel content less than about 10% by weight.

It is preferred that the formed allylic copolymer has a bimodal molecular weight distribution. By “bimodal” it is meant that gel permeation chromatography (GPC) analysis of a copolymer sample reveals two or more distinct molecular weight regions, which may or may not overlap. At least two “peak” molecular weights are evident.

Copolymers from the process of the invention are valuable for toners. Typical toner compositions include a copolymer, a pigment, and other optional components such as flow-control additives, magnetic pigments, charge-control additives, and the like. Toner compositions of the invention comprise an allylic copolymer of the invention and other conventional components. The allylic monomer allows polymer/resin formulators to incorporate important functional groups (e.g., hydroxyl, amine, ester, ether) evenly throughout the copolymer chain. These functional groups can enhance the triboelectric properties of the copolymer, help to disperse the pigments, improve pigment wetting and adhesion of the toner to paper, improve anti-offset or fusion properties, and/or boost abrasion resistance. The copolymers are also expected to have excellent friability, i.e., they will make toners easy to pulverize compared with conventional toner polymers/resins.

The copolymers of the invention can also be used in thermosets, which normally include, in addition to the copolymer, a crosslinking agent and other optional components such as fillers, thickeners, pigments, and other additives. The crosslinking agent reacts with functional groups in the copolymer. Because the copolymers of the invention have an unusually broad molecular weight distribution, they should lend unique properties to a variety of thermoset products made with them.

The copolymers of the invention are also valuable as reactive plasticizers. In thermoplastics such as polyvinyl chloride (PVC), for example, non-reactive plasticizers such as dioctyl phthalate are commonly used. However, these tend to leach out of the thermoplastic over time. The present copolymers overcome the leaching problem by reacting into the polymer network.

The copolymers also have value as rheology modifiers for coatings. Desirable compositions will have low viscosity under high shear conditions (e.g., during spraying from a nozzle), but will have high viscosity at low shear (e.g., during film formation on the substrate). The copolymers of the invention, because of their uniquely broad molecular weight distribution, will offer coating formulators a high degree of flexibility in modifying rheology.

The copolymers can also be combined with polyester monomers (glycols, anhydrides, diacids) for the synthesis of “hybrid resins” (see, e.g., U.S. Pat. Nos. 5,153,261 and 5,296,544). Moreover, the copolymers can be combined with glycol diacrylates to make conventional, UV-curable coatings, or they can be used in powder coatings as high T_{g}, crosslinkable copolymers with low melt viscosity. The copolymers can even replace unsaturated polyester resins in applications such as hot-melt, thermoplastic adhesives. In sum, the copolymers of the invention have wide utility limited only by the imagination of the skilled practitioner.

The following examples merely illustrate the invention. Those skilled in the art will recognize many variations that are within the spirit of the invention and scope of the claims.

### EXAMPLE 1

Synthesis of Toner Resin (With Water)

A 1-liter glass reactor equipped with an agitator, a temperature controller, a monomer addition funnel, a condenser, and a nitrogen inlet, is charged with allyl monopropoxylate (40 g, product of Lyondell Chemical Company) and distilled water (42.5 grams). The reactor contents are purged with nitrogen for 30 minutes. Styrene (256 g), n-butyl methacrylate (64 g), divinylbenzene (1.5 g, 80%, product of Aldrich) and di-tert-butyl peroxide (20 g) are mixed and charged into the addition funnel. The reactor is initially charged with 39.5 grams of the mixture, and is heated to 145° C. under the protection of nitrogen. The remaining mixture is added into the reactor over a period of 6 hours as follows: first hour, 78 g; second hour, 66 g; third hour, 54 g; fourth hour, 44 g; fifth hour, 34 g; and sixth hour, 26 g. The reaction is allowed to continue for an additional 30 minutes at 145° C. after the completion of addition. During the course of reaction, no stirring problem was encountered. The water and unreacted monomers is removed by vacuum distillation at 155° C. with nitrogen purging. The product (362.5 g) is collected (85.5% yield). The resulting copolymer is colorless and has good clarity. GPC shows two main peaks at 10⁴ and 10⁶. The product has Mn: 6,010, Mw: 104,600, glass transition temperature (Tg, by DSC): 65° C., and toluene insoluble portion: 1% by weight.

### EXAMPLE 2

Synthesis of Toner Resin (With Water)

A 5-liter stainless steel reactor equipped with an agitator, a temperature controller, a monomer addition pump and initiator pump and a nitrogen inlet, is charged with allyl monopropoxylate (260 g, product of Lyondell Chemical Company) and distilled water (362 grams). The reactor contents are purged with nitrogen for 30 minutes and sealed. Styrene (1344 g), n-butyl methacrylate (336 g) and divinylbenzene (12.6 g, 80%, product of Aldrich) are mixed charged into the monomer addition pump; di-tert-butyl peroxide (105 g) is charged into initiator pump. Initially the reactor is charged with 190.5 grams of monomer mixture and 12 grams of di-tert-butyl peroxide, and is heated to 145° C. The remaining monomer mixture and di-tert-butyl peroxide are added into the reactor over a period of 6 hours as follows: monomer: first hour, 385 g; second hour, 325 g; third hour, 265 g; fourth hour, 220 g; fifth hour, 170 g; and sixth hour, 130 g; initiator: first hour, 24 g; second hour, 20.5 g; third hour, 16.5 g; fourth hour, 13.5 g; fifth hour, 10.5 g; and sixth hour, 8 g. The reaction is allowed to continue for an additional 30 minutes at 145° C. after the completion of addition. During the course of reaction, no stirring problem was encountered. The water and unreacted monomers is removed by vacuum distillation at 155° C. with nitrogen purging. The product (1904 g) is collected (78.7% yield). GPC shows two main peaks at 10⁴ and 10⁶. The product has Mn: 5,350, Mw: 152,100, glass transition temperature (T_{g}, by DSC): 67° C., and toluene insoluble portion: 1% by weight.

### EXAMPLE 3

Synthesis of Toner Resin (With Polyvinyl Alcohol Aqueous Solution)

A reactor as described in Example 2, is charged with allyl monopropoxylate (260 g) and a polyvinyl alcohol aqueous solution (1.25% of PVA, 362 grams). The reactor contents are purged with nitrogen for 30 minutes. Styrene (1344 g), n-butyl methacrylate (336 g) and divinylbenzene (12.6 g, 80%, product of Aldrich) are mixed charged into the monomer addition pump; di-tert-butyl peroxide (105 g) is charged into initiator pump. Initially the reactor is charged with 190.5 grams of monomer mixture and 12 grams of di-tert-butyl peroxide, and is heated to 145° C. The remaining monomer mixture and di-tert-butyl peroxide are added into the reactor over a period of 6 hours at the same rate described in Example 2. The reaction is allowed to continue for an additional 30 minutes at 145° C. after the addition. During the course of reaction, no stirring problem was encountered. The water and unreacted monomer is removed by vacuum distillation at 155° C. with nitrogen purging. The product (1979 g) is collected (81.8% yield). The resulting copolymer is colorless and has good clarity. GPC shows two main peaks at 10⁴ and 10⁶. The product has Mn: 5,740 and Mw: 164,500, T_{g}: 67° C.

### Comparison Example 4

Synthesis of Toner Resin (Without Water)

A reactor as described in Example 2 is charged with allyl monopropoxylate (260 g, product of Lyondell Chemical Company). The reactor contents are purged with nitrogen for 30 minutes and sealed. Styrene (1344 g), n-butyl methacrylate (336 g) and divinylbenzene (12.6 g, 80%, product of Aldrich) are mixed charged into the monomer addition pump; di-tert-butyl peroxide (105 g) is charged into initiator pump. Initially the reactor is charged with 190.5 grams of monomer mixture and 12 grams of di-tert-butyl peroxide, and is heated to 145° C. The remaining monomer mixture and di-tert-butyl peroxide are added into the reactor over a period of 6 hours at the same rate described in Example 2. The reaction mixture became difficult to stir during the 5th hour.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A process for making allylic copolymers having broad molecular weight distribution, said process comprising:
free radically copolymerizing a reaction mixture comprising:
(i) a monomer mixture comprising:
a) a mono-ethylenic monomer;
b) a multi-ethylenic monomer;
c) a mono-allylic monomer; with
(ii) an aqueous dispersing agent;
wherein the multi-ethylenic monomer and the mono-allylic monomer are used in amounts sufficient to produce a copolymer having a weight average molecular weight (Mw) greater than about 10,000, a molecular weight distribution (Mw/Mn) greater than about 5, and a gel content less than about 10% by weight.

2. The process of claim 1 wherein the aqueous dispersing agent is present in the reaction mixture in an amount of about 4 to about 50 weight percent, based on the total weight of the reaction mixture.

3. The process of claim 1 wherein the aqueous dispersing agent comprises at least about 95 weight percent water, based on the total weight of the aqueous dispersing agent.

4. The process of claim 3 wherein the aqueous dispersing agent consists essentially of water.

5. The process of claim 3 wherein the aqueous dispersing agent comprises an aqueous solution of colloidal stabilizers, surfactants, and mixtures thereof.

6. The process of claim 5 wherein the aqueous dispersing agent is selected from the group consisting of polyvinyl alcohol, soluble starch, hydroxyethyl cellulose, sodium stearate, and sodium dodecylbenzene sulfonate.

7. The process of claim 1 wherein the mono-ethylenic monomer is used in an amount sufficient to produce a copolymer having a T_{g} greater than about 50° C.

8. The process of claim 1 wherein the mono-ethylenic monomer is selected from the group consisting of vinyl aromatics, C₁ to C₂₀ alkyl and C₆ to C₂₀ aryl acrylates and methacrylates, vinyl halides, vinyl ethers, vinyl esters, acrylic and methacrylic acids, conjugated dienes, and mixtures thereof.

9. The process of claim 1 wherein the mono-ethylenic monomer is a mixture of styrene and butadiene.

10. The process of claim 1 wherein the mono-ethylenic monomer is a mixture of styrene and methyl methacrylate.

11. The process of claim 1 wherein the multi-ethylenic monomer is selected from the group consisting of divinyl aromatics, diacrylates, dimethacrylates, and mixtures thereof.

12. The process of claim 1 wherein the multi-ethylenic monomer is divinylbenzene.

13. The process of claim 1 wherein the mono-allylic monomer is selected from the group consisting of alkyl and methallyl alcohols, ethoxylated allyl and methallyl alcohols of 1 to 5 oxyethylene units, and propoxylated allyl and methallyl alcohols of 1 to 5 oxypropylene units.

14. The process of claim 1 wherein the mono-allylic monomer is used in an amount within the range of about 5% by weight to about 40% by weight, and the multi-ethylenic monomer is used in an amount within the range from about 0.1% by weight to about 10% by weight.

15. The process of claim 1 wherein at least about 50% by weight of a) and b) are added to the reaction mixture in a gradual manner.

16. The process of claim 1 wherein the copolymer has a bimodal molecular weight distribution.
